(19) United States
(12) Patent Application Publication
(10) Pub. No.: US 2018/0301058 A1
(43) Pub. Date: Oct. 18, 2018

(54) System and Method for Managing Dietary Habits with an Interactive Wearable Band and Sensors

(71) Applicant: Joseph Smith, Los Angeles, CA (US)

(72) Inventor: Joseph Smith, Los Angeles, CA (US)

(21) Appl. No.: 15/485,672

(22) Filed: Apr. 12, 2017

(51) Int. Cl. G09B 19/00; G09B 5/06

(52) U.S. Cl. CPC G09B 19/0092; G09B 5/06

(57) ABSTRACT

A system and method for managing dietary habits with an interactive wearable band and sensors helps a user become more aware of dietary habits by monitoring body parts, such as the jaw, and food vessels, like a refrigerator door. The system visually and audibly monitors, alerts, and displays the at least one variable event through use of an interactive wearable band. The band has an ornamental component. The band communicates with at least one sensor operable near a body part or a food vessel. The sensors detect a variable event near the body part or the food vessel. An integrated wireless data communication interface receives information related to the variable event and transmit the information to a processor for storage and processing. The band displays the dietary habit information. A speaker in the band emits audible commands in multiple languages to the user pertinent to the dietary habits.

### FIELD OF THE INVENTION

The present invention relates generally to a system and method for managing dietary habits with an interactive wearable band and sensors. More so, the present invention relates to a system and method for monitoring, alerting, and displaying the diet habits of a user through use of an interactive wearable band that communicates with at least one sensor operable near a body part, such as the jaw, or a food vessel, such as a refrigerator; whereby the sensor detects a variable event near the jaw or the food vessel, such as an up-and-down motion of the jaw or a lid being displaced relative to the food vessel; whereby the interactive wearable band includes a wireless data communication interface configured to receive information related to the variable event and transmit the information externally for storage and processing; whereby the interactive wearable band processes and displays the information to the user so that the user can better understand and be more aware of dietary habits; whereby the interactive wearable band includes a speaker to transmit audible signals to the user pertinent to the dietary habits; whereby the audible commands can be preprogrammed to speak in a plurality of languages; and whereby the interactive wearable band may be configured to have an ornamental effect, such as leather casing or jeweled components.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

It is known in the art that educating and informing people is very important to help them to comply with lifestyle changes, such as changing dietary habits. The overwhelming amount of healthcare information that is available via the mass media is typically information about nutritional choices. This information is confusing to some and if followed without adequate supervision by a nutritionist may, in some cases, lead to an increase in unhealthy food choices in an otherwise unhealthy lifestyle.

Often, medical and dietary professionals recognize that there is a need to improve the dissemination of information to motivated individuals about eating for both health and pleasure, which will lead to decreased health care costs and increased health benefits such as increased life expectancy, improved quality of life, and prevention of certain diseases and their complications.

Generally, the industry diet and exercise tracking products include: i) wearable fitness devices (e.g. Fitbit, Jawbone Up, smartwatches with fitness tracking (e.g. Apple iWatch, etc.)); and ii) mobile and desktop devices executing diet and fitness applications (“apps”) (e.g. MyFitnessPal, Lose It, etc.). Wearable fitness devices provide automatic sensor-based tracking of general physical activities, such as walking or movement. Tens of millions of wearable fitness devices have been sold and the product segment is rapidly growing. Wearable fitness devices may be in the form of, or integrated with, wrist-secured bands, smartwatches or clothes attachable/embedded devices.

It is widely recognized that the wearable fitness devices were innovative products upon their first arrival to the market; and they provided a significantly more efficient method for tracking general exercise activity than that which is provided by the known conventional fitness apps. However, while wearable fitness devices are indeed very efficient for simple exercise tracking (e.g., how many steps did you walk, what distance did you walk, how many calories did you burn, etc.), they are deficient in other important ways, such as monitoring and alerting to dietary habits.

Other proposals have involved dietary management systems and methods. The problem with these dietary plans is that they are not wearable, so as to stay attached to a user. Also, the jaw is not monitored to determine body habits. Also, food vessels are not monitored to detect dietary habits do not magnify the force applied around the hose, and they are not compactable for facilitated stowage and transport. Even though the above cited dietary management systems meet some of the needs of the market, a system and method for managing dietary habits with an interactive wearable band and sensors. More so, the present invention relates to a system and method for monitoring, alerting, and displaying the diet habits of a user through use of an interactive wearable band that communicates with at least one sensor operable near a body [part, such as the jaw, or a food vessel, such as a refrigerator is still desired.

### SUMMARY

Illustrative embodiments of the disclosure are generally directed to a system and method for managing dietary habits with an interactive wearable band and sensors. The system and method of managing dietary habits serves to visually and audibly monitor, alert, and display the dietary habits of a user through use of an interactive wearable band that communicates with at least one sensor operable near a body part or a food vessel. The sensor detects at least one variable event near the body part, such as a jaw moving in an up-and-down chewing motion during ingestion; or a lid on the food vessel being displaced relative to an opening.

The interactive wearable band includes an integrated wireless data communication interface configured to receive information related to the variable event from the sensor and transmit the information to a processor for storage and processing. The processor provides an algorithm that calculates the variable event over a duration to generate quantitative data related to dietary habits so that the user can better understand and be more aware of dietary habits.

The interactive wearable band may include a speaker to transmit audible signals to the user pertinent to the dietary habits. The audible commands may be preprogrammed to speak in a plurality of languages. The interactive wearable band may be configured to have an ornamental component, such as leather casing or jeweled components.

In one embodiment, a system for managing dietary habits with an interactive wearable band and sensors comprises an interactive wearable band defined by an outer surface and an inner surface. The interactive wearable band is configured to be donned by a user, such as on the wrist. An ornamental member may be integrated in the interactive wearable band.

In some embodiments, the system may include at least one sensor that is disposed proximally to a jaw or a food vessel. The at least one sensor detects at least one variable event near the jaw or the food vessel. The variable event may include an up-and-down motion of the jaw during ingestion, and a lid being displaced relative to the food vessel.

In some embodiments, the system may include a wireless data communication interface that is operational with the interactive wearable band. The wireless data communication interface is in communication with the at least one sensor. The wireless data communication interface is configured to receive information related to the at least one variable event and transmit the information externally for storage and processing.

In some embodiments, the system may include a processor operational with the interactive wearable band. The processor is configured to process the information related to the at least one variable event. In this manner, the processer employs an algorithm that computes at least one dietary habit based on the at least one variable event.

In some embodiments, the system may include a display screen is operational with the interactive wearable band to display the at least one dietary habit. Further, a speaker is operational with the interactive wearable band to audibly emit the at least one dietary habit. This may occur in multiple languages.

In another aspect, the interactive wearable band is a wrist band.

In another aspect, the ornamental member is a leather casing or a stone.

In another aspect, the at least one sensor includes at least one of the following: a motion sensor, a pressure sensor, an acoustic sensor, a piezoelectric sensor, and a capacitive sensor.

In another aspect, the wireless data communication interface is operable with radio waves.

In another aspect, the wireless data communication interface comprises a transmitter, or a receiver, or both.

In another aspect, the at least one variable event includes at least one of the following: the jaw moving in an up-and-down motion, and a lid being displaced relative to the food vessel.

In another aspect, the algorithm computes the number of up-and-down motions of the jaw and the number of displacements of the lid in a duration.

In another aspect, the system comprises a power source.

In another aspect, the power source is a button coin cell.

In another aspect, the interactive wearable band is defined by an outer surface and an inner surface.

In another aspect, the display screen is a digital display screen sized to be displayed on the outer surface of the interactive wearable band.

In another aspect, the system comprises a power switch.

In another aspect, the speaker is a high volume speaker.

In another aspect, the audible emitting of the at least one dietary habit is in a plurality of languages.

One objective of the present invention is to provide an interactive wearable band that interacts with a user about dietary habits while being donned by the user.

Another objective is to enable a user to decide whether the amount of calories taken in by consuming selected food elements.

Another objective is to provide an interactive wearable band that is ornamental.

Yet another objective is to operatively connect the at least one sensor with a section of the body or a food vessel and then detect specific motions that indicate a dietary habit.

Yet another objective is to visually and audibly indicate the dietary habit though the display screen and the speaker.

Yet another objective is to speak the dietary habits in multiple languages.

Yet another objective is to provide adaptable sensors that can work with various food vessels and their lids.

Yet another objective is to decrease health care costs and increase health benefits such as increased life expectancy, improved quality of life, prevention of certain diseases, and their complications.

Yet another objective is to provide an easy to use system and method for regulating and being aware of dietary habits.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a block diagram of an exemplary system for managing dietary habits, in accordance with an embodiment of the present invention;

FIG. 2 illustrates a perspective view of an exemplary interactive wearable band, in accordance with an embodiment of the present invention; and

FIG. 3 illustrates a flowchart of an exemplary method for managing dietary habits, in accordance with an embodiment of the present invention.

Like reference numerals refer to like parts throughout the various views of the drawings.

### DETAILED DESCRIPTION OF THE INVENTION

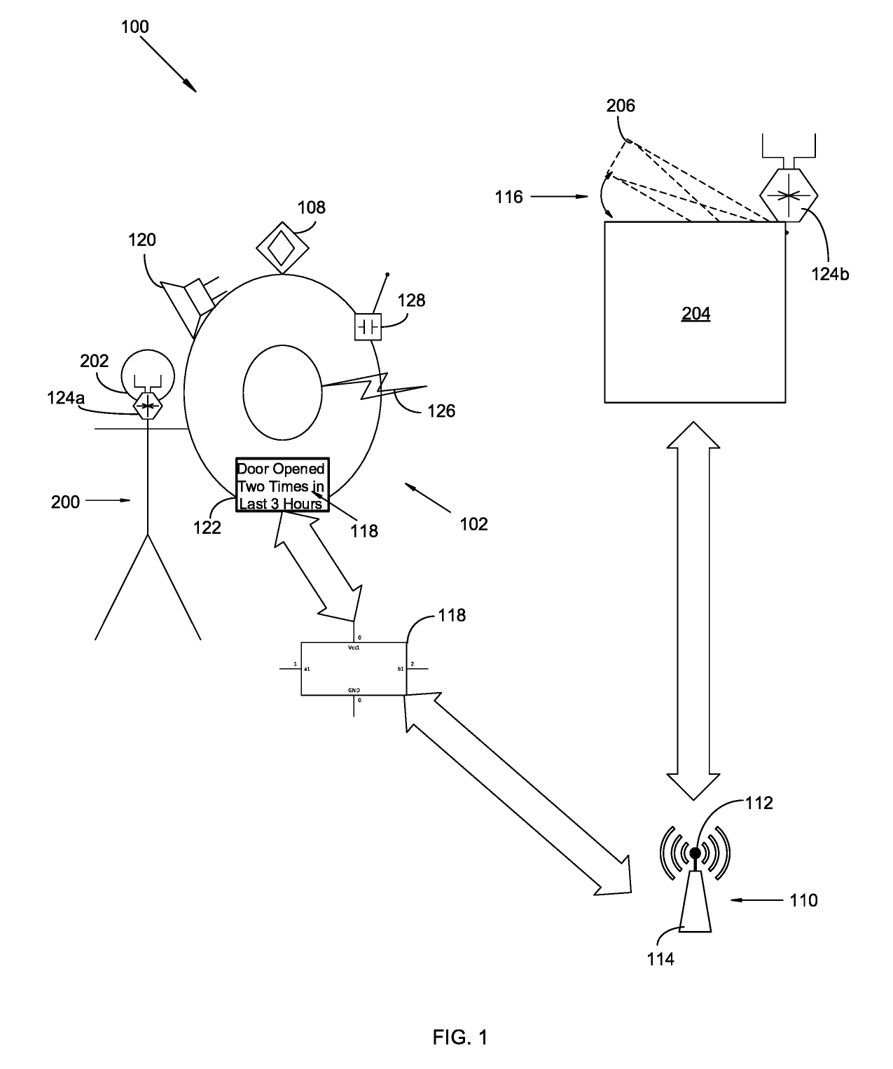

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

A system 100 and method 300 for managing dietary habits with an interactive wearable band and sensors is referenced in FIGS. 1-3. The system 100 and method 300 for managing dietary habits, hereafter “system 100” and “method 300” provides a wearable dietary tool that is employed to inform the user 200 about a dietary habit 118 by detecting at least one variable event 116 on the user's body part 202, i.e., the jaw, and a food vessel 204, i.e. refrigerator.

The system 100 and method 300 provides an interactive wearable band 102 that is worn by the user 200. The interactive wearable band 102 remains in communication with at least one sensor 124a, 124b. The sensor 124a, 124b is operable near the body part 202, or the food vessel 204, or both. The sensor 124a, 124b is employed to monitor movements by the body part 202 and the food vessel 204 that are indicative of dietary habits 118, such as amount of food swallowed during ingestion, or the number of times a refrigerator door is opened and closed in a duration. In this manner, a user 200 can adjust dietary habits 118 and more specifically, decide the amount of calories taken in by consuming selected food elements in appropriate quantities.

As referenced in FIG. 1, the system 100 and method 300 visually and audibly monitors, alerts, and displays the dietary habits 118 of a user 200 through use of an interactive wearable band 102 that communicates with at least one sensor 124a-b operable near the body part 202 or the food vessel 204. The sensor 124a-b detects at least one variable event 116 near the body, such as a jaw moving in an up-and-down chewing motion during ingestion; or a food vessel 204, such as a lid 206 being displaced relative to a food vessel 204.

The interactive wearable band 102 also includes an integrated wireless data communication interface 110 configured to receive information from the sensor 124a-b related to the variable event 116 and transmit the information to a processor 118 for storage and processing. The processor 118 comprises an algorithm that processes the variable event information to generate quantitative data that can then be deduced by a dietary professional, or the user 200, to better understand and be more aware of dietary habits 118.

The interactive wearable band 102 may include a speaker 120 to emit audible signals to the user 200 that are pertinent to the dietary habits 118. In one possible embodiment, the audible commands may be preprogrammed to speak in a plurality of languages. The interactive wearable band 102 may be configured to have an ornamental member 108, such as leather casing, gold, or stones. A power source 126 and a power switch 128 also help to regulate the interactive wearable band 102.

Those skilled in the art will recognize that educating and informing people about their dietary habits is vital to help them to comply with lifestyle changes, such as quantitative and qualitative food consumption. The overwhelming amount of healthcare information that is available is typically information about nutritional choices. This information is confusing to some and if followed without adequate supervision by a nutritionist may, in some cases, lead to an increase in unhealthy food choices in an otherwise unhealthy lifestyle.

Thus, there is a need to improve the dissemination of information to motivated individuals about eating for both health and pleasure. Consequently, the present system and method is designed to lead to decreased health care costs and increased health benefits such as increased life expectancy, improved quality of life, prevention of certain diseases and their complications.

The system 100 and method 300 can be especially efficacious for a user 200 who wishes to modify their nutrition and diet behavior. The user 200 can enroll in the method during which they are simultaneously exposed to two nutrition education pathways. Whilst participating in the method 300, the user's knowledge of, and skills in, human nutrition science and general health matter progressively increases.

Moreover, the long-term benefits of a user 200 participating in the method 300 are that there would be a noticeable decrease in health care costs both to the person and to the health care insurers, and a significant increase in their motivation to comply with the knowledge skills learnt in the method 300 of the present invention. A further advantage of the modified nutrition/diet behavior would be a reduction in the incidence of obesity and problems associated therewith such as, for example, adult onset diabetes.

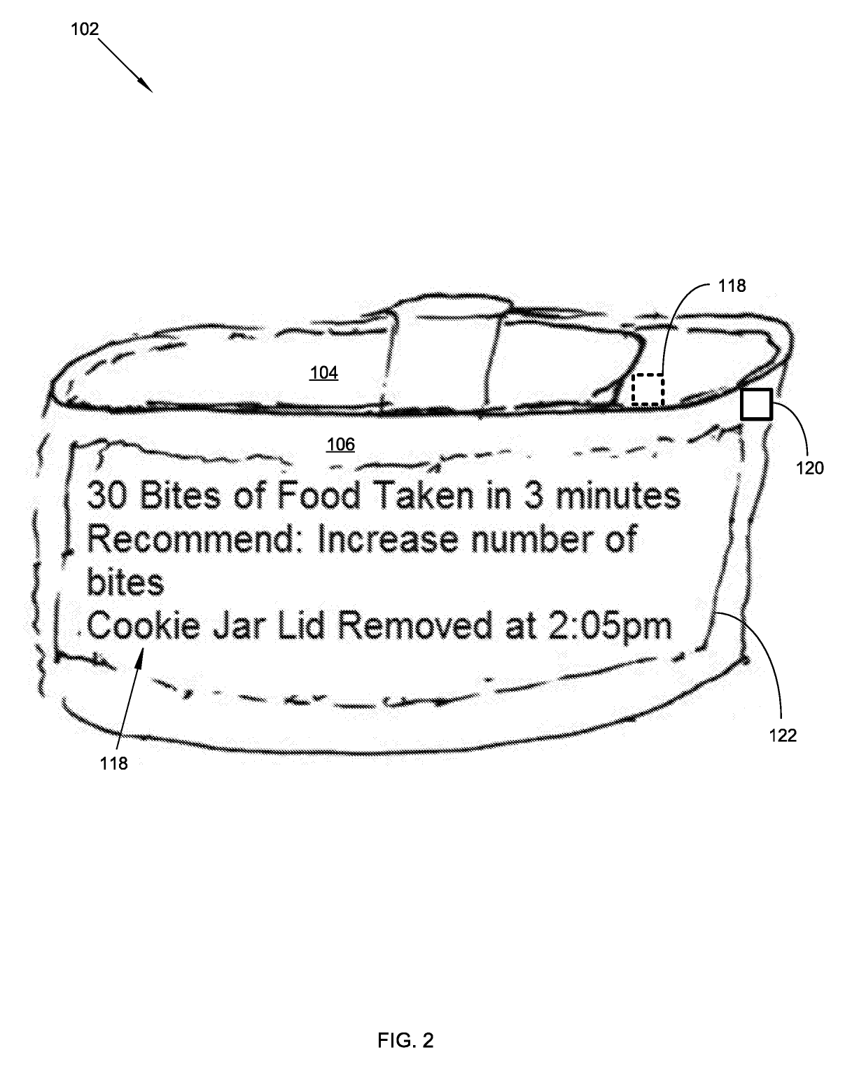

Turning now to FIG. 2, the system 100 comprises an interactive wearable band 102. The interactive wearable band 102 is donned by the user 200 around the wrist, ankle, neck, or arm. The interactive wearable band 102 interacts with a user 200 to receive and process at least one variable event 116 that is collected by at least one sensor 124a-b, and is pertinent to a dietary habit 118 of the user 200. The variable event 116 is processed in the interactive wearable band 102, and the resultant quantitative information informs about the dietary habits 118 of the user 200.

In one embodiment, the interactive wearable band 102 is defined by an inner surface 104 and an outer surface 106 that form a generally cylindrical band 102. In one embodiment, the interactive wearable band 102 is generally cylindrical and fabricated from a pliable polymer. The inner surface 104 may be padded and sweat absorbent to provide comfort to the user 200. The interactive wearable band 102 is sized and dimensioned to fit around a wrist or an ankle; and is thereby donnable by a user 200. Though in other embodiments, the interactive wearable band 102 can be donned on the neck, arm, torso, or other body part that allow for facilitated interactivity.

In some embodiments, an ornamental member 108 may be integrated in the interactive wearable band 102. The ornamental member 108 may include a leather or gold casing that encapsulate the outer surface 106 of the interactive wearable band 102. The ornamental member 108 may also include, without limitations, a precious stone, a semi-precious stone, a pendant, an image, a pattern, a color, and a texture. Thus, the interactive wearable band 102 is both functional and stylistic.

Looking back at FIG. 1, the system 100 includes at least one sensor 124a-b that is disposed proximally to a body part 202 of the user 200, or a food vessel 204 having a lid 206. The sensor 124a-b detects at least one variable event 116 near the jaw or the food vessel 204. The variable event 116 may include an up-and-down motion of the jaw during ingestion, and a lid 206 being displaced relative to the food vessel 204. The sensor 124a-b can detect a variation of the characteristic including variation indicative of an individual swallowing when the sensor 124a-b is positioned in a neck area of the individual, or a lid 206 or door being opened to access food items contained in the cavity of the food vessel 204. In some embodiments, the sensor 124a-b may include, without limitation, a motion sensor, a pressure sensor, an acoustic sensor, a piezoelectric sensor, and a capacitive sensor.

In operation, the sensor 124a-b is operational proximal to the body part 202, such as tied around the neck to detect motion by the jaw, neck, mouth, or hand. In one embodiment, the sensor 124a-b detects the motion of the jaw through infrared or laser implementations. The number of up-and-down motions by the jaw can be detected and transmitted to a processor 118 for further processing, as discussed below.

For example, the sensor 124a-b detects thirty chews in a 3 minute duration. This may indicate the dietary habit 118 of number of chews or swallows during ingestion. The analysis of this dietary habit 118 can indicate that the user 200 should chew more or less before swallowing. The sensor may be a precise sensor that detects the size of the lump of food in the throat of the user 200. This detection may indicate a dietary habit of taking bites that are too large.

However, the chewing dietary habit detected around the jaw could also indicate the speed of the jaw movement, so as to determine if the user 200 is swallowing too quickly before finishing to chew. This is yet another unique dietary habit 118 that is presented to the user 200 in quantitative presentation that helps the user 200 manage dietary habits 118. It is also significant to note that a dietary professional is equipped to recognize the dietary habits 118 that can be derived from the information collected by the sensor 124a-b.

Other body parts 202 that could be detected by the sensor 124a-b may include, without limitation, 1) a hand to detect the number of movements towards the mouth; 2) a belly to detect the number of compressions during ingestion; and 3) a leg to determine the number of steps to a food vessel 204. In any case, the relationship of the body with food is measured to determine dietary habits 118.

In another exemplary operational use of the sensor 124a-b to determine a dietary habit 118, a pressure sensor 124a-b is operational at an opening in a refrigerator or cookie jar to detect the number of times a door or lid 206 is displaced in relation to an opening. In this manner, the number of times the refrigerator or cookie jar is opened for accessing the food item can be monitored, and the user 200 can be informed in a generated report. The displacement of the door or lid 206 can be useful for quantifying the amount of trips to the food vessel 204, or the length of time the lid remains open, which may not be apparent to the user 200 otherwise.

Other food vessels that may be detected by the sensor 124a-b may include, without limitation, a food cabinet, a freezer, an oven, a silverware drawer, a glove box, and any general receptacle of food items. The sensor 124a-b may detect the lid 206, door, cover, opening, and electronic components of each type of food vessel 204. In this manner, access to the contents thereof are quantitatively assessed.

Looking again at FIG. 1, the system 100 may include a wireless data communication interface 110 that is operational with the interactive wearable band 102. The wireless data communication interface 110 is in communication with the sensor 124a-b. In one embodiment, the wireless data communication interface 110 is operable with radio waves. Though in other embodiments, Internet and Bluetooth protocol may be used for transmitting data with the wireless data communication interface 110.

The wireless data communication interface 110 is configured to receive information related to the at least one variable event 116 and transmit the information externally for storage and processing. The wireless data communication interface 110 may utilize a receiver 114, or a transmitter 112, or both to communicate with an external data storage unit or a processor 118 that is integrated in the interactive wearable band 102. For example, when the sensor 124a-b detects the jaw motion in a three minute interval, the number of up-and-down motions is transmitted from the sensor 124a-b to a processor 118 in the interactive wearable band 102.

The processor 118 is operational with the interactive wearable band 102. The processor 118 is configured to process the information related to the at least one variable event 116 in determining the dietary habit 118 of the user 200. In this manner, the processor 118 employs an algorithm that computes at least one dietary habit 118 based on the at least one variable event 116. In one embodiment, the algorithm computes the number of up-and-down motions of the jaw. The algorithm may also compute the number of displacements of the lid 206 in a duration that are received from the sensor 124b.

In one exemplary calculation, the algorithm may simply count the number of chews or lid 206 displacements, and then divide this number by a period of time. The resultant indicates a chew per second or an opening per hour. The algorithm may then utilize a spreadsheet to generate a quantitative report for viewing by the user 200. However in other embodiments, the algorithm may calculate averages, means, and other statistical data known in the art to provide quantitative data that can be used by a dietary professional to deduce a dietary habit 118. In this manner, the system 100 uses the information related to the variable events 116 to identify eating habits and type of food eaten. Feedback may be provided to the user 200 to help the user 200 change their dietary intake and habits 118.

In some embodiments, the system 100 may include a display screen 122 that is operational with the interactive wearable band 102. The display screen is employed to display a dietary habit 116 based on the at least one dietary habit 118. The display screen 122 may include a digital display or a touch screen sized to be displayed on the outer surface 106 of the interactive wearable band 102.

Further, a speaker 120 is operational with the interactive wearable band 102 to audibly emit the at least one dietary habit 118. The audible signal may include a synthetic voice that speaks in multiple languages. Though in other embodiments, the audible signals may include, without limitation, beeps, sirens, and even vibratory signals from an integrated vibrator.

In some embodiments, the system 100 comprises a power source 126 to power the electrical components of the interactive wearable band 102. The power source 126 may include a button coin cell, a rechargeable battery, a solar cell, or a USB for receiving power from an external power source 126. A power switch 128 may be used to power on and off the interactive wearable band 102.

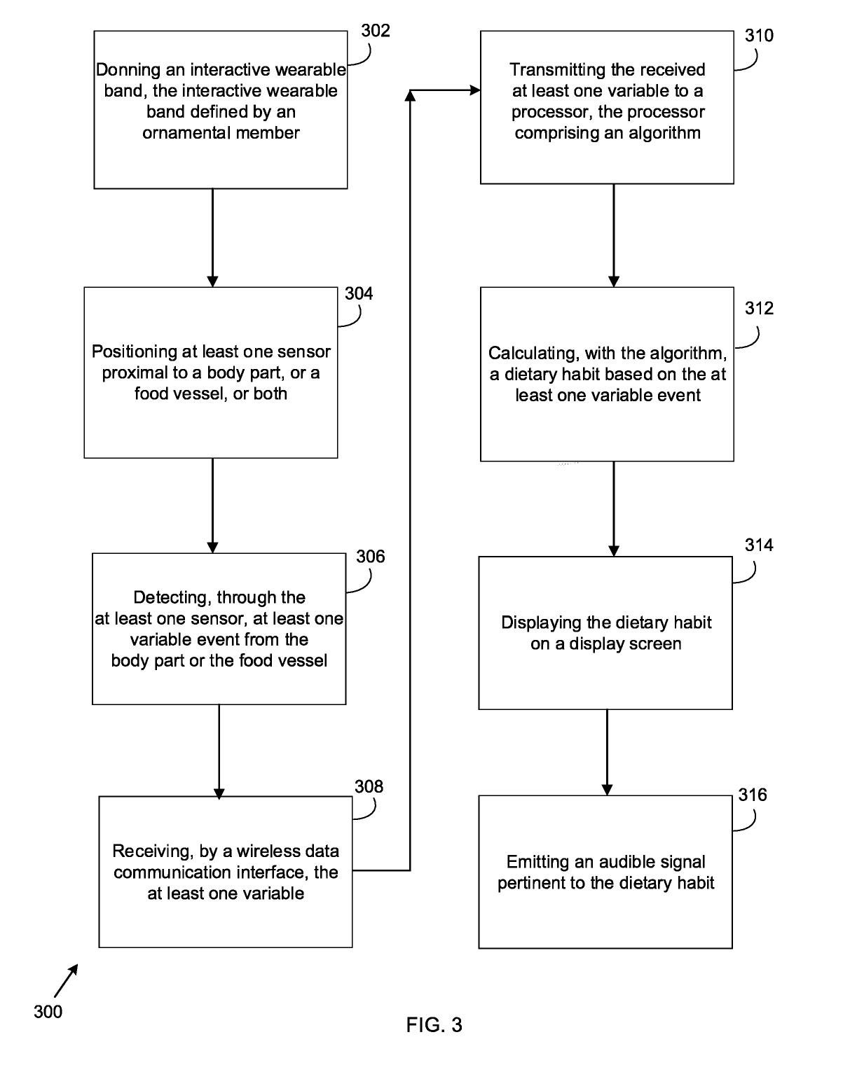

FIG. 3 illustrates a flowchart of an exemplary method 300 for managing dietary habits. The method 300 provides a wearable dietary tool that interacts with a user 200 to make the user 200 more aware of dietary habits 118 by monitoring the user's 200 body part 202s, i.e., the jaw, and proximal food vessels 204, i.e. refrigerator door for at least one variable event 116.

The method 300 allows an interactive wearable band 102 to remain in communication with at least one sensor 124a-b. The sensor 124a-b is operable near the body part 202 and a food vessel 204. The sensor 124a-b is employed to monitor movements by the jaw and food vessel 204 that are indicative of dietary habits 118, such as amount of food swallowed during ingestion, or the number of times a refrigerator door is opened and closed in a predefined duration.

The method 300 may include an initial Step 302 of donning an interactive wearable band 102, the interactive wearable band 102 defined by an ornamental member 108. The method 300 may further comprise a Step 304 of positioning at least one sensor 124a-b proximal to a body part 202, or a food vessel 204, or both. A Step 306 includes detecting, through the at least one sensor 124a-b, at least one variable event 116 from the body part 202 or the food vessel 204.

In some embodiments, a Step 308 comprises receiving, by a wireless data communication interface 110, the at least one variable. A Step 310 includes transmitting the received at least one variable to a processor 118, the processor 118 comprising an algorithm. In some embodiments, a Step 312 may include calculating, with the algorithm, a dietary habit 118 based on the at least one variable event 116. A Step 314 comprises displaying the dietary habit 118 on a display screen 122. A final Step 316 includes emitting an audible signal pertinent to the dietary habit 118 from a speaker 120.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A system for managing dietary habits, the system comprising:
an interactive wearable band defined by an outer surface and an inner surface, the interactive wearable band configured to be donned;
an ornamental member integrated in the interactive wearable band;
at least one sensor configured to be disposed proximally to a body part or a food vessel, the at least one sensor configured to detect at least one variable event near the body part or the food vessel;
a wireless data communication interface operational with the interactive wearable band, the wireless data communication interface in communication with the at least one sensor, the wireless data communication interface configured to receive information related to the at least one variable event and transmit the information externally for storage and processing;
a processor operational with the interactive wearable band, the processor configured to process the information related to the at least one variable event,
whereby the processer employs an algorithm that computes at least one dietary habit based on the at least one variable event;
a display screen operational with the interactive wearable band, the display screen configured to display the at least one dietary habit; and
a speaker operational with the interactive wearable band, the speaker configured to audibly emit the at least one dietary habit.

2. The system of claim 1, wherein the interactive wearable band is a resilient wrist band.

3. The system of claim 1, wherein the ornamental member includes at least one of the following: a leather casing, gold, silver, a precious stone, a semi-precious stone, an image, a pattern, and a color.

4. The system of claim 1, wherein the at least one sensor includes at least one of the following: a motion sensor, a pressure sensor, an acoustic sensor, a piezoelectric sensor, and a capacitive sensor.

5. The system of claim 1, wherein the wireless data communication interface is operable with radio waves.

6. The system of claim 1, wherein the wireless data communication interface comprises a transmitter, or a receiver, or both.

7. The system of claim 1, wherein the at least one variable event includes at least one of the following: the body part moving in an up-and-down motion, and a lid being displaced relative to the food vessel.

8. The system of claim 1, wherein the algorithm computes the number of up-and-down motions of the body part and the number of displacements of the lid in relation to the food vessel that occur in a duration.

9. The system of claim 1, further comprising a power switch.

10. The system of claim 1, further comprising a power source.

11. The system of claim 10, wherein the power source includes at least one of the following: a button coin cell, a rechargeable battery, a solar panel, and USB port.

12. The system of claim 1, wherein the display screen is a digital display screen sized to be displayed on the outer surface of the interactive wearable band.

13. The system of claim 1, wherein the speaker is a high volume speaker.

14. The system of claim 1, wherein the audible emitting of the at least one dietary habit is in a plurality of languages.

15. The system of claim 1, wherein the body part includes at least one of the following: a jaw, a mouth, a neck, a belly, a hand, and a leg.

16. The system of claim 1, wherein the food vessel is operable with a lid, the food vessel including at least one of the following: a refrigerator, a cookie jar, a food cupboard, a silverware drawer, and a glove box.

17. One or more computer storage media storing computer-usable instructions, that when used by one or more computing devices, cause the one or more computing devices to perform a method for managing dietary habits, the method comprising:
donning an interactive wearable band, the interactive wearable band defined by an ornamental member;
positioning at least one sensor proximal to a body part, or a food vessel, or both;
detecting, through the at least one sensor, at least one variable event from the body part or the food vessel;
receiving, by a wireless data communication interface, the at least one variable;
transmitting the received at least one variable to a processor, the processor comprising an algorithm;
calculating, with the algorithm, a dietary habit based on the at least one variable event;
displaying the dietary habit on a display screen; and
emitting an audible signal pertinent to the dietary habit.

18. The system of claim 17, further comprising a step of powering on the interactive wearable band with a power switch.

19. The system of claim 17, further comprising a step of converting the audible signal to a synthetic voice that speaks in a plurality of languages.

20. One or more computer storage media storing computer-usable instructions, that when used by one or more computing devices, cause the one or more computing devices to perform a method for managing dietary habits, the method consisting of:
donning an interactive wearable band, the interactive wearable band defined by an ornamental member;
powering on the interactive wearable band with a power switch;
positioning at least one sensor proximal to a body part, or a food vessel, or both,
whereby the at least one sensor includes at least one of the following: a motion sensor, a pressure sensor, an acoustic sensor, a piezoelectric sensor, and a capacitive sensor,
whereby the body part includes at least one of the following: a jaw, a mouth, a neck, a belly, a hand, and a leg,
whereby the food vessel includes at least one of the following: a refrigerator, a cookie jar, a food cupboard, a silverware drawer, and a glove box;
detecting, through the at least one sensor, at least one variable event from the body part or the food vessel;
receiving, by a wireless data communication interface, the at least one variable;
transmitting the received at least one variable to a processor, the processor comprising an algorithm, the algorithm operable to compute the number of up-and-down motions of the body part and the number of displacements of a lid in relation to the food vessel that occur in a duration;
calculating, with the algorithm, a dietary habit based on the at least one variable event;
displaying the dietary habit on a display screen;
emitting an audible signal pertinent to the dietary habit from a speaker; and
converting the audible signal to a synthetic voice that speaks in a plurality of languages.
